(19) United States
(12) Patent Application Publication
(10) Pub. No.: US 2004/0102866 A1
(43) Pub. Date: May 27, 2004

(54) Modelling for surgery

(76) Inventors: Simon James Harris, London (GB); Brian Lawrence Davies, London (GB)

Correspondence Address: Wallenstein & Wagner Ltd, 53rd Floor, 311 South Wacker Drive, Chicago, IL, 60606-6630, US

(21) Appl. No.: 10/470,313

(22) PCT Filed: Jan. 29, 2002
(86) PCT No.: PCT/GB02/00404

(30) Foreign Application Priority Data
Jan. 29, 2001 (GB) 0102246.6
Jan. 29, 2001 (GB) 0102252.4
Jan. 29, 2001 (GB) 0102255.7
Jan. 29, 2001 (GB) 012254.0

(51) Int. Cl. G06F 19/00

(52) U.S. Cl. 700/117; 700/98

(57) ABSTRACT

The invention in its various forms relates generally to surgical planning methods, and in particular to the planning of surgical operations to implant a prosthesis. In a first embodiment, the surgeon uses an interactive system to design both the shape of the prosthesis and the shape of the bone. In a second embodiment, a modified Marching Cubes algorithm is used to simulate cutting planes within bones. In a third embodiment, back-projection is used within a computer model to allow an integrated display of both bone and prosthesis. In a fourth embodiment, an interactive system is used to test the mobility of a proposed implant, prior to undertaking a surgical operation.

The present invention relates to modelling for surgery. In its various aspects, it relates particularly although not exclusively to computer modelling for prosthetic surgery, and modelling the design of implants and prosthetic components.

A first aspect of the present invention relates to a NURBS-based modelling method for use in surgical planning, in particular for knee implants and custom-designed osteotomy implants.

NURBS provides an approach to geometry where surfaces can be described in terms of continuous smooth curves as opposed to tesselated facets.

According to a first aspect of the present invention there is provided a method of forming a prosthesis component, comprising the steps of: generating a bone model including a NURBS surface describing a cut surface of a bone to which a prosthesis component is to be fitted; providing a prosthesis shell model describing a prosthesis component, the prosthesis component including at least one fitting surface; displaying superimposed representations of the bone model and the prosthesis model; translating and/or rotating one or both of the bone model and the prosthesis model to represent one fit of the prosthesis component to the bone; modifying the prosthesis model by re-modelling the fitting surface of the prosthesis model to include the NURBS surface; generating a modified prosthesis model; and forming a prosthesis component from the modified prosthesis model.

In one embodiment the prosthesis component is a knee implant. For knee replacement procedures. NURBS provides a method of describing implants, allowing for the generation of custom-fitted implants. Using a NURBS-based model of the knee, for example, the curvature of the femoral condyles, allows implants to be custom formed to fit over the condyles with only a minimum of bone removal. Such a methodology is only appropriate for robotic fabrication since the implants would be custom made for a particular patient, and the curves would be unique and complex, making the use of a mechanical template or a pre-shaped cutting tool impossible. In addition, the NURBS surface can be modified to include surface features, such as bumps or ridges, which can be used as location points to ensure correct fitting between the bone and the prosthesis component, allowing for good bone re-growth into the prosthesis component.

In another embodiment the prosthesis component is an osteotomy component. In osteotomies, for example, in the removal of a cancerous section of bone for replacement with a custom-milled implant, NURBS provides a method of describing both the bone resection and the implant geometry.

In planning, an interactive NURBS modeller is used, allowing a surgeon to fit surfaces to the bone to. be machined, while a NURBS-based active-constraint robot system will be used in machining the bone.

The first aspect of the invention further extends to a method of modelling for use in surgical planning, the method comprising:

(a) generating a bone model including a NURBS surface describing a first fitting surface of a bone to which a prosthesis component is to be fitted;

(b) providing a prosthesis shell model describing a prosthesis component, the prosthesis component including a second fitting surface;

(c) displaying superimposed representations of the bone model and prosthesis model;

(d) translating and/or rotating one or both of the bone model and the prosthesis model to represent one fit of the prosthesis component to the bone;

(e) modifying the prosthesis or bone model by re-modelling at lease one of the respective fitting surfaces:

(f) generating a modified bone or prosthesis model;

(g) passing the bone model to a surgical robot; and

(h) using the prosthesis shell model to generate a prosthesis component.

The first aspect also extends to a method of modelling for use in surgical planning, the method comprising:

(a) generating a bone model describing a first fitting (cut) surface of a bone to which a prosthesis component is to be fitted;

(b) providing a prosthesis shell model describing a prosthesis component, the prosthesis component including a second fitting surface;

(c) displaying superimposed representations of the bone model and prosthesis model;

(d) translating and/or rotating one or both of the bone model and the prosthesis model to represent one fit of the prosthesis component to the bone;

(e) modifying the prosthesis or bone model by re-modelling at least one of the respective fitting surfaces;

(f) generating a modified bone or prosthesis model;

(g) passing the bone model to a surgical robot; and

(h) outputting the prosthesis shell model for use in the generation of a prosthesis component.

According to a second aspect of the present invention there is provided a surface modelling method for modelling a three-dimensional surface, comprising. the steps of: (a) determining any polygon in one voxel and the voxels adjacent thereto of a surface to be modelled; (b) determining. the polygon vertices of each determined polygon; (c) encoding the polygon vertices as bit patterns, comprising, for each polygon vertex, the steps of: (c1) encoding the polygon vertex as a bit pattern; (c2) scanning a vertex list for the bit pattern; (c3) including the bit pattern in the vertex list where the pattern is not in the vertex list; and (c4) including an index of the bit pattern in a polygon table; (d) repeating steps (a) to (c) for the other voxels of the surface to be modelled; and (e) generating a vertex list and associated polygon table.

Preferably, each bit pattern includes the x, y and z voxel co-ordinates and a direction code representing the direction relative to the voxel co-ordinates.

More preferably, the method further comprises the steps of: (f) determining the z co-ordinate from one of the bit patterns; (g) obtaining data for the cached image slices around the determined z co-ordinate; (h) interpolating between voxels based on grey level and the direction code; (i) generating a true x, y and z co-ordinate for the vertex; (j) repeating steps (f) to (i) for the other bit patterns; and (k) generating an x, y and z co-ordinate table for the vertices.

Yet more preferably, for any z co-ordinate, the cached image slices are slices z−1, z and z+1.

Preferably, the polygons comprise triangles.

These modelling methods have a number of advantages over existing modelling methods. Firstly, there are no holes in the mesh of triangles and cut planes are rendered as flat surfaces. Secondly, there is no need to manipulate the topology of the system, that is, no modifications need be made to the connectivity of the mesh, only co-ordinates are moved. Thirdly, no fill-in processing is required as the fill-in co-ordinates are automatically determined.

In the second aspect, the invention further extends to a surface modelling method for modelling a three-dimensional surface comprising:

(a) determining any polygon in one voxel and the voxels adjacent thereto of a surface to be modelled;

(b) determining the polygon vertices of each determined polygon;

(c) encoding the polygon vertices as bit patterns, comprising, for each polygon vertex, the steps of:

(c1) encoding the polygon vertex as a bit pattern;

(c2) scanning a vertex list for the bit pattern;

(c3) including the bit pattern in the vertex list where the pattern is not in the vertex list; and

(c4) including an index of the bit pattern in a polygon table;

(d) repeating steps (a) to (c) for the other voxels of the surface to be modelled; and

(e) generating a vertex list and associated polygon table.

A third aspect of the present invention relates to the simulation of cutting planes in bones, including modification of the Marching Cubes algorithm. In particular, the present invention relates to the visualisation of cut surfaces and the cut bones merged with a prosthesis model.

Total knee replacement (TKR) surgery, for example, requires the cutting of a plurality of flat planes, typically five flat planes on the femur and one flat plane on the tibia. Normally, these planes are set at the onset of the operation using a series of jigs. and fixtures. In the case of a robotic system where operative plans are generated pre-operatively, it is necessary to manipulate images of the bones and prosthesis components on a computer to determine alignment.

To date, bones have been modelled by voxel models, and surgery has been simulated by removing the voxels that would be removed during the surgical procedure, that is, usually the voxels on the distal side of the cutting planes relative to the centre of the condyles for the femur and the bone above the cutting plane for the tibia. The voxel models. are usually rendered and displayed in 3D to allow visualisation of the surgical results. The merging of the prosthesis models with the voxel models has required that the prosthesis models be converted into voxel models and added to the bone models. Because the process of voxel removal requires the manipulation of large amounts of data, typical bone models requiring millions of voxels, the process is relatively slow. Moreover, conversion of the prosthesis models to voxels also increases the processing time.

Prosthesis components are modelled with two sets of data:

(1) Surface polygon meshes which describe the surface of the prosthesis components as a set of small, connected polygons that can be rapidly rendered in 3D.

(2) Cutting planes which consist of plane centres and unit vectors along the surfaces of the cutting planes in nominally X and Y directions and surface normals in a nominal Z direction. These co-ordinates and vectors represent the position and orientation of each cutting plane.

The prosthesis model can be manipulated by translating and rotating the surface polygon mesh and cutting plane information together.

The bone model comprises a surface model of the bone which is extracted from CT data automatically using a Marching Cubes algorithm. See Lorensen, W. E., Cline H. E. ‘Marching Cubes: A High Resolution 3D Surface Construction Algorithm’ Computer Graphics—Vol. 21, No. 4, July 1987, pp 163-169. This allows the model to be rendered rapidly, typically using 3D graphics hardware common in modern computers, and to be rotated, translated and scaled easily by simple geometrical operations.

The resulting model of the bone surface from the Marching Cubes algorithm is a set of small triangles. This model has a form similar to the prosthesis CAD model, allowing the models to be merged easily with the bone model.

In a simplest form, the bones could be cut simply by testing each triangle vertex from the bone model to determine which side of a cutting plane the vertex lies. If any vertex lies in the cut-away portion of the bone, the associated triangle would then be removed. This method has the significant drawback that rather than leave flat planes on the bone, large holes would be generated, as the bone model is essentially a thin skin and not a solid. These holes would be very noticeable if just the bones were to be visualised, and, even with the prosthesis components merged, would still at least be partially noticeable since bone covered by the prosthesis components does not usually exactly match the flat planes cut during surgery. The modelled images would include disconcerting gaps in the bone between the bone and the outline of the prosthesis. It would, of course, be possible to fill in the gaps to generate flat surfaces, but the outlines of these filled-in regions would be arbitrarily shaped. Also, where several regions require filling, the fill-in process would be complex.

It is an aim of this aspect of the present invention to provide improved modelling methods for enabling the representation of cutting planes on bone surfaces.

It is a particular aim of this aspect of the present invention to provide an improved modelling method in which no triangles are actually removed from the mesh, but rather repositioned onto the cutting surfaces.

According to this aspect of the present invention there is provided a modelling method, comprising the steps of: generating a bone model of a surface of a bone to which a prosthesis component is to be fitted by generating at least one polygon for each voxel on the surface of the bone as imaged; providing a prosthesis model describing a prosthesis component, the prosthesis component including at least one fitting surface; displaying superimposed representations of the bone model and the prosthesis model; translating and/or rotating one or both of the bone model and the prosthesis model to represent one fit of the prosthesis component to the bone; determining the relative translation and/or rotation of the at least one fitting surface of the prosthesis. component; generating at least one modified bone model by re-positioning the vertices of the polygons of the bone model onto the at least one fitting surface of the prosthesis component; and displaying the at least one modified bone model.

In one embodiment the bone surface is an outer surface of the bone, for example, the outer bone surface removed in a knee replacement.

In another embodiment the bone surface is a surface of a cavity in the bone, for example, the inner bone surface removed in a hip replacement.

Preferably, the polygons comprise triangles.

The third aspect further extends to a modelling method, comprising:

(a) generating a bone model of a surface of a bone to which a prosthesis component is to be fitted by generating at least one polygon for each voxel on the surface of the bone as imaged;

(b) providing a prosthesis model describing a prosthesis component, the prosthesis component including a fitting surface;

(c) displaying superimposed representations of the bone model and the prosthesis model;

(d) translating and/or rotating one or both of the bone model and the prosthesis model to represent one fit of the prosthesis component to the bone;

(e) determining the relative translation and/or rotation of the fitting surface of the prosthesis component;

(f) generating a modified bone model by re-positioning the vertices of the. polygons of the bone model onto the fitting surface of the prosthesis component; and

(g) displaying the modified bone model.

A fourth aspect of the present invention relates to a method of assessing the fit of a prosthesis component prior to surgery.

Unlike with manual surgery, where prosthesis components are positioned with respect to jigs and fixtures, robot-based surgery uses pre-operative plans based on an interactively-selected set of component positions. The components thus have to be positioned correctly to prevent excessive wear, and to give a good range of motion for the leg of a patient.

In a manually-performed knee replacement procedure, the fit of the two prosthesis components is governed by the alignment of jig components and tested in situ. In the case of a robot-controlled procedure, where the prosthesis components are positioned pre-operatively using 3D modelling techniques, a method is required to ensure that the fit is correct on the model before entering the operating theatre. The fit effects (i) the tightness of the joint—a joint which is too tight will wear excessively, (ii) the range of motion of the knee—a poorly aligned prosthesis will limit the range of motion possible to a less than ideal angular range, and (iii) the gait—a poorly aligned knee will result in an incorrect valgus angle of the knee, leading to an incorrect walking posture.

The positions of the prosthesis components and the lengths of the ligaments will govern the range of motion at the knee. Processing of these aspects is therefore required to validate the prosthesis planning prior to surgery.

According to this aspect of the present invention there is provided a method of enabling the optimisation of the fit of prosthesis components, comprising the steps of: displaying superimposed representations of prosthesis components as fitted to respective bones; positioning the prosthesis models of the prosthesis components to represent one fit of the prosthesis components to the bones; modelling the relative movement of the prosthesis components as limited by a constraint model; indicating the interference of ones of the prosthesis components and the bone; re-positioning the prosthesis models of the prosthesis components relative to the bones to represent another fit of the prosthesis components to the bones; re-modelling the relative movement of the prosthesis components as limited by the constraint model; repeating the re-positioning and re-modelling steps to achieve a desired fit of the prosthesis components; and generating position data representative of the relative positions of the bone and prosthesis models for subsequent operation.

Preferably, the interference of ones of the prosthesis components and the bone is indicated visually.

More preferably, the visual indication of interference is indicated by colour coding.

Preferably, the method further comprises the step of: generating cutting data from the position data for subsequent bone cutting.

Prosthesis models are usually described as a set of surface facets representing the outer exterior surfaces of the prosthesis components and the bone mating surfaces. Cutting planes are usually represented by plane centre points and unit vectors along the axes of the surface of each plane.

In a conventional knee replacement prosthesis, there are five flat planes for the femoral component and one flat plane for the tibial component. Descriptions of the tracking between the prosthesis components are also used to determine the contact points of the prosthesis components as the knee is rotated. The surface facets of the bone models are extracted from the CT data using a Marching Cubes algorithm, resulting in a mesh of adjoining small triangles. These models are then processed to represent the cuts made by the surgeon to fit the prosthesis as described herein.

The following information can be obtained by the modelling method:

(1) The range of motion of the tibia relative to the femur. By processing the models along with the ligament lengths as described below,. it is possible to determine allowable configurations in which the bone/prosthesis models do not interfere with each other and the ligaments are not stretched, and impossible configurations in which the bones interfere and the ligaments are excessively stretched.

(2) The likely wear on the prosthesis due to tightness. Where prosthesis components begin to interfere with each other as a result of tightness, the wear will be greater. This wear can be recorded on the triangulated mesh used to represent the prosthesis.

(3) The typical gait of the patient within the available range of motion. By transforming the tibial bone model by the possible rotation angles within the range of motion, relative to the angles set-up for the prosthesis components, the motion of the ankle during a typical flexion/extension cycle can be visualised. If the load-bearing axis, here hip-knee-ankle, is not correctly aligned, the surgeon can adjust the prosthesis positioning and re-test.

The fourth aspect further extends to a method of enabling the optimization of the fit of first and second relatively-moveable prosthesis components, comprising:

(a) positioning a prosthesis model of the first prosthesis component. with respect to a first (cut) bone model, and a prosthesis model of the second prosthesis component with respect to a second (cut) bone model. to define respective first and second fitting models;

(b) simulating relative movement between the prosthesis components by moving one fitting model with respect to the other, subject to a constraint model;

(c) indicating any interference between the first and second fitting models;

(d) re-positioning the respective models of the first and second fitting models, and re-simulating movement;

(e) repeating (d) until a desired fit is achieved; and

(f) generating position data representative of the first and second fitting models for use in subsequent operation.

The invention may be carried into practice in a number of ways and some specific embodiments will now be described, by way of example, with reference to the accompanying drawings in which:

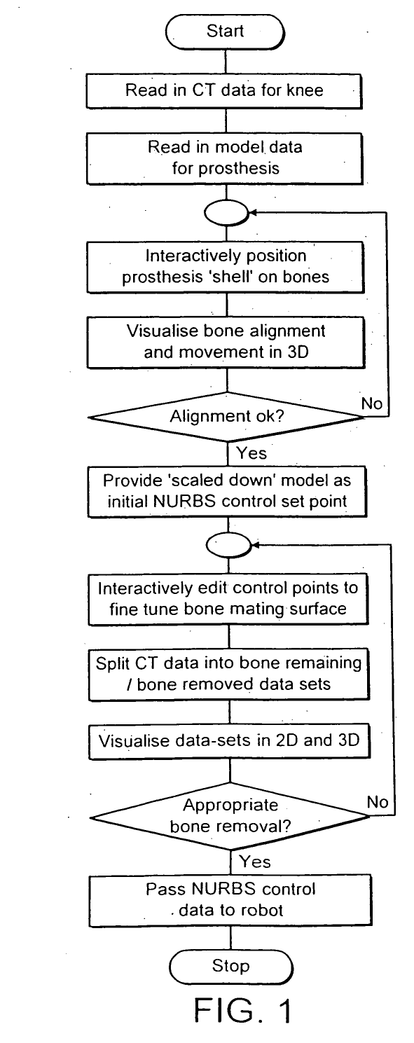

FIG. 1 is a flowchart for one modelling method according to an embodiment of the invention for knee replacement planning;

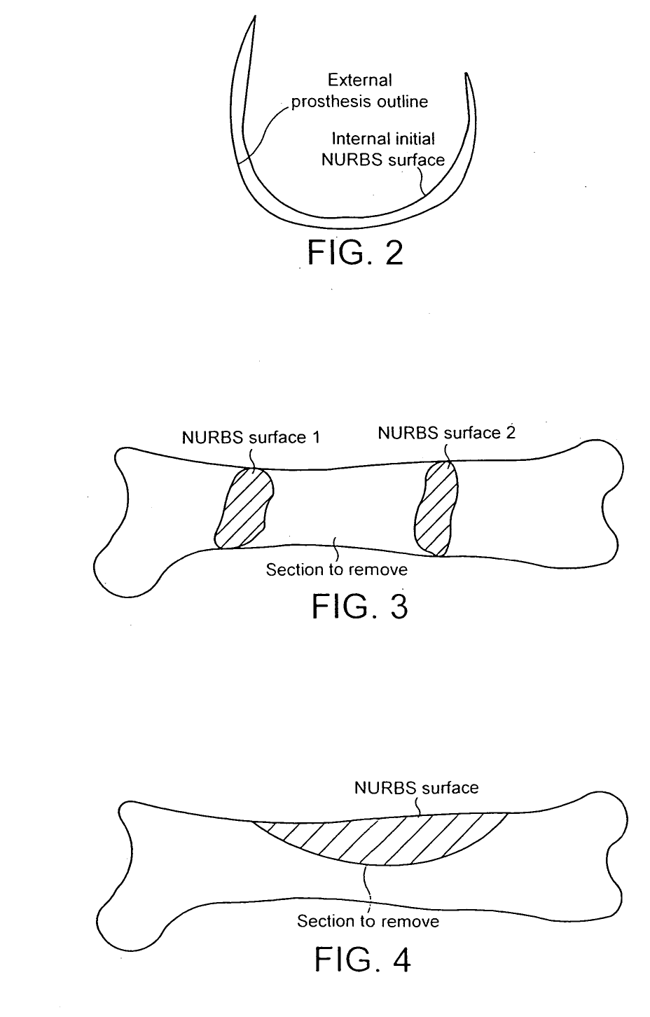

FIG. 2 illustrates a side view of the outer-surface of a prosthesis and an inner NURBS surface;

FIG. 3 illustrates a complete bone section removal;

FIG. 4 illustrates the removal of a region of the bone;

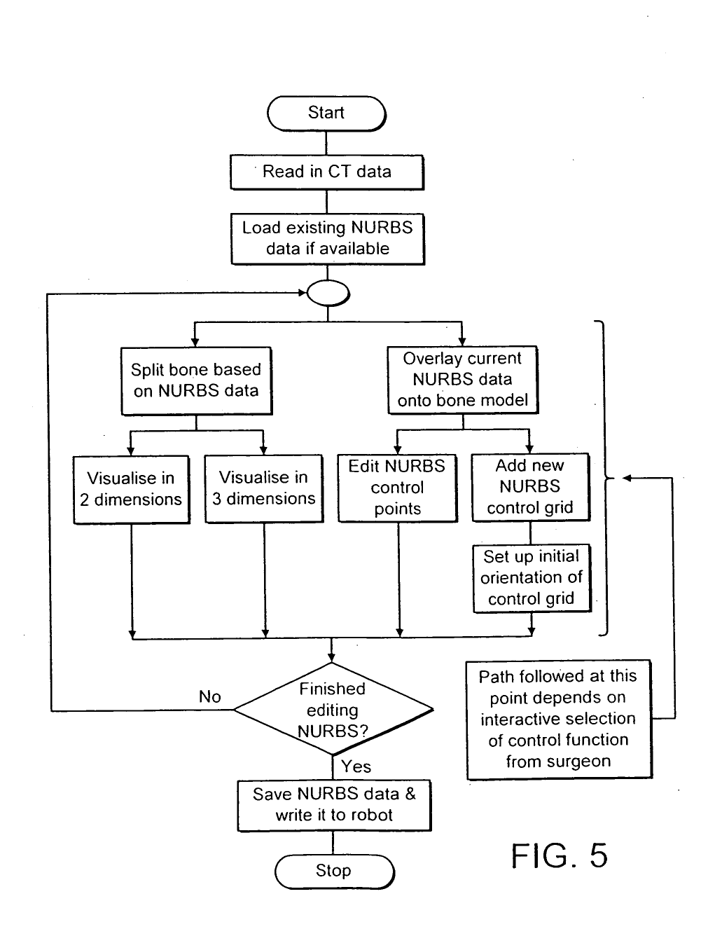

FIG. 5 is a flowchart showing one preferred NURBS-based osteotomy planner;

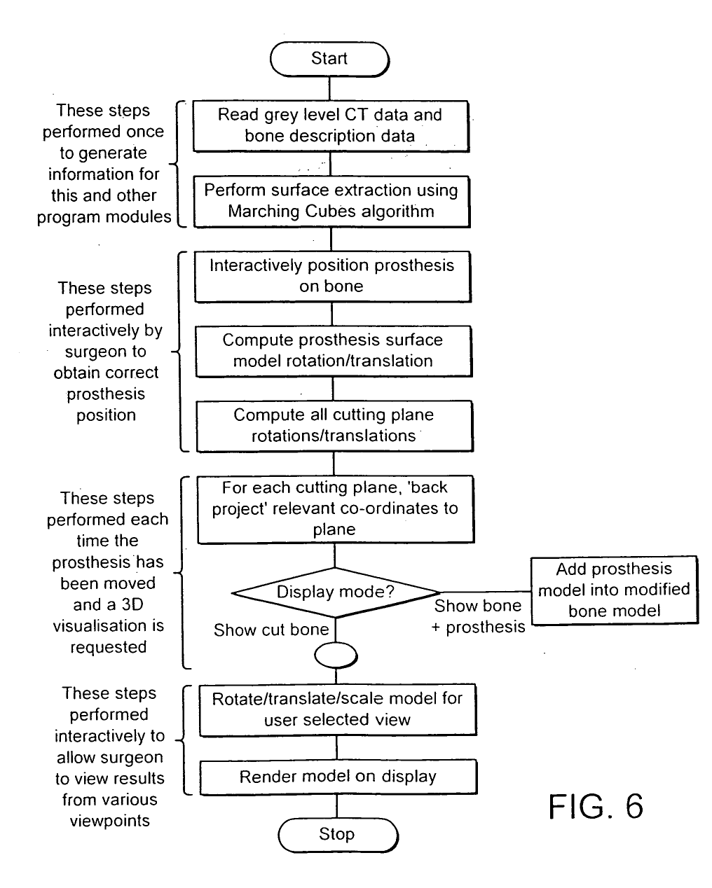

FIG. 6 is a flowchart of a modelling method for the simulation of cutting planes in bones;

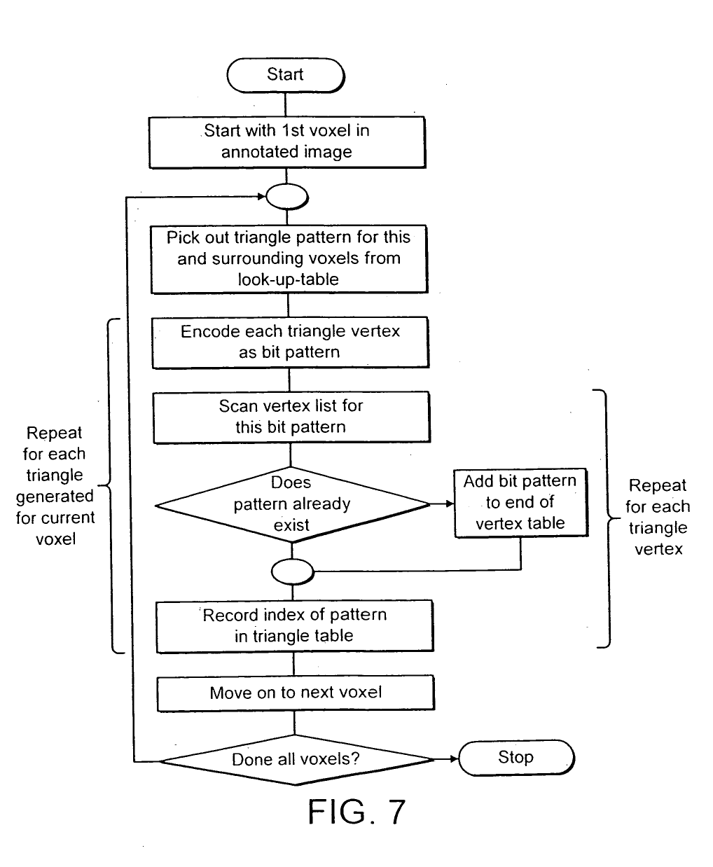

FIG. 7 is a flowchart for the first pass of the modelling method shown in FIG. 6;

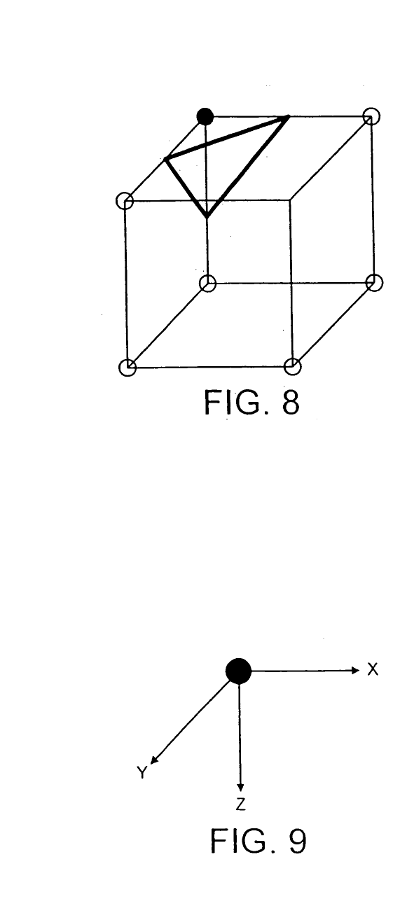

FIG. 8 illustrates a simple case in which a bone edge just impinges onto a group of eight voxels;

FIG. 9 illustrates the axes used in the computation;

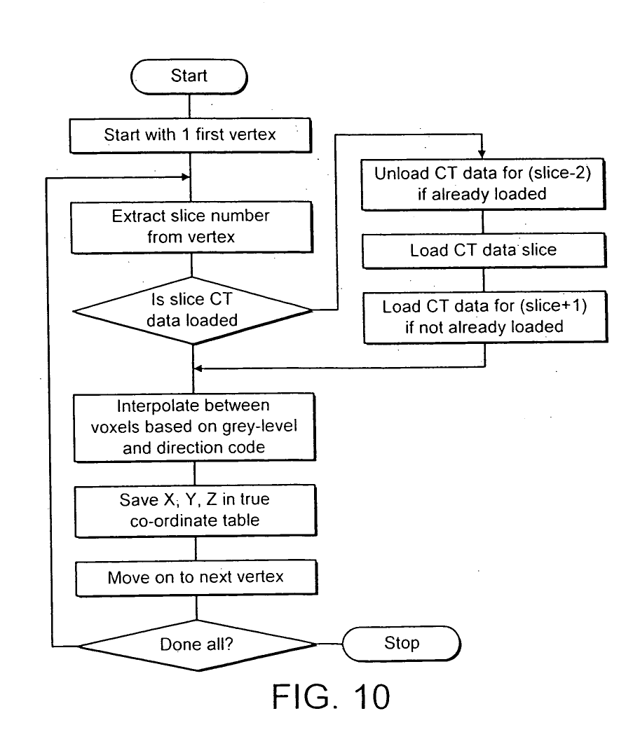

FIG. 10 is a flowchart for the second pass of the modelling method of FIG. 6;

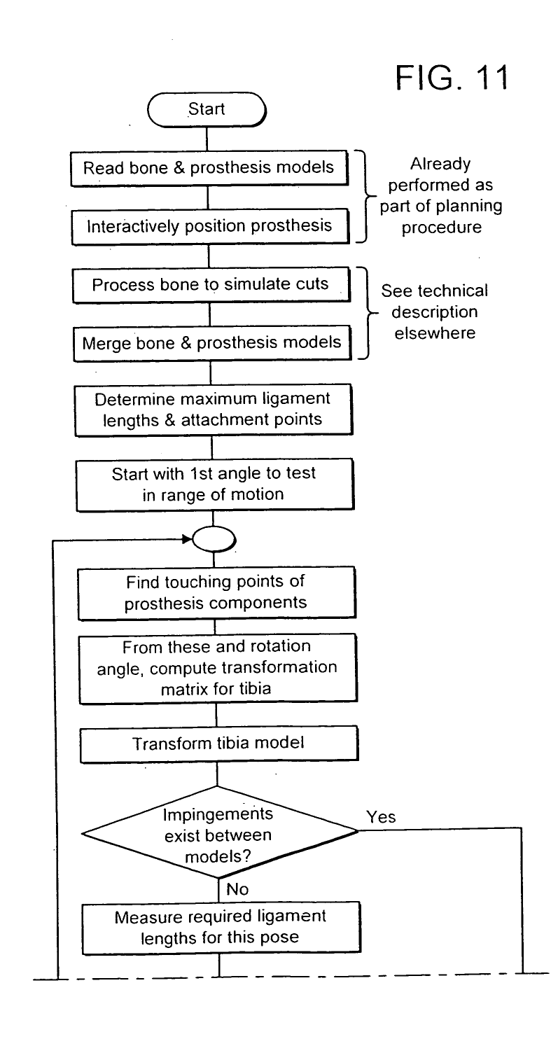

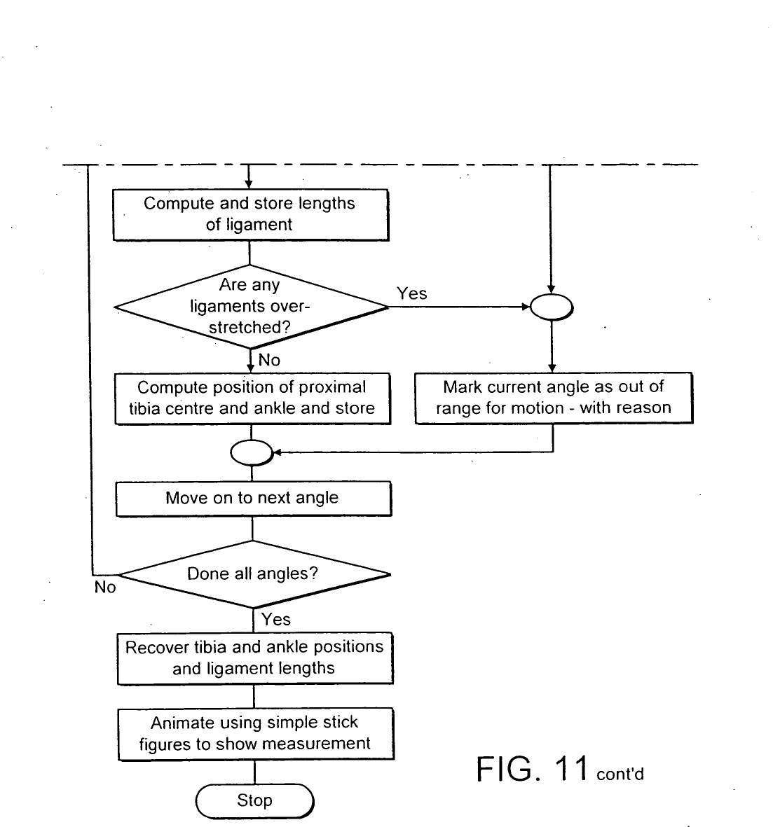

FIG. 11 is a flowchart of a mobility testing method according to a preferred embodiment of the invention;

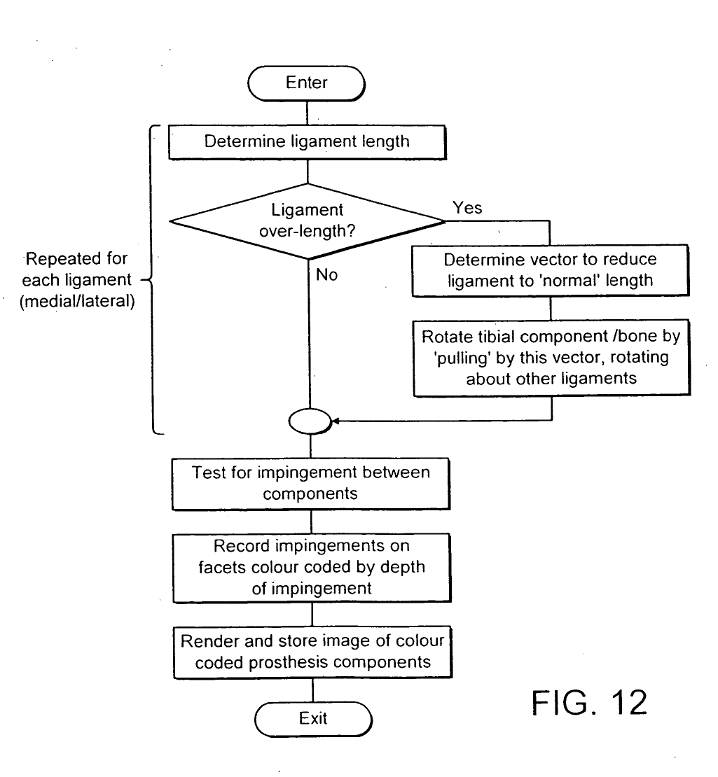

FIG. 12 is a flowchart showing a wear test carried out in conjunction with the testing method of FIG. 11;

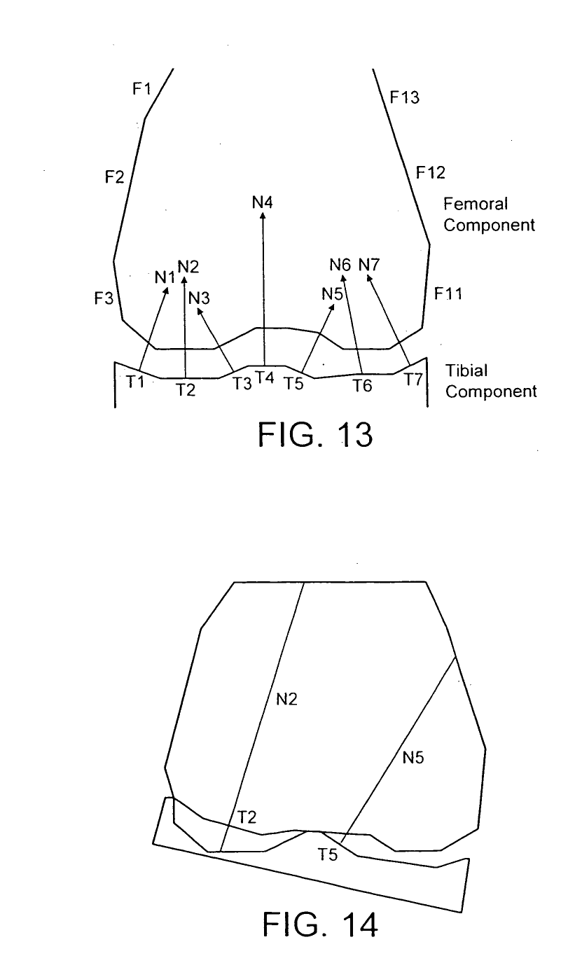

FIG. 13 illustrates a simplified example of the use of the method shown in FIG. 11; and

FIG. 14 shows the situation where there is some intersection between the femoral and tibial components.

We refer first to FIGS. 1 to 5 which illustrate a preferred modelling method for use in surgical planning, and in particular for knee implants and custom-designed osteotomy implants. In the preferred method, a surgeon models both the final shape of the bone (including those areas to be cut away) and those parts of a prosthetic implant which, when the operation is carried out, will fit against the cut bone surfaces.

We will first consider knee replacement planning.

FIG. 1 illustrates a flowchart for one modelling method in knee replacement planning.

An interactive approach is used to plan the knee replacement surgery using a NURBS-based system, with CT data and a set of knee prosthesis shells being the starting point for modelling. The outside of each prosthesis shell is fixed since the purpose of knee replacement is to replace damaged bone surfaces. The existing surfaces cannot be relied upon to provide a good approximation of the required geometry.

Planning is a two-stage process. In a first stage, a prosthesis shell is positioned on a CT-based model of the knee, with planning tools described herein being used to test the location of the prosthesis. In a second stage, when the outer geometry is finalised, the inner geometry, that is. the bone interface, is planned. Based around the outer shell surface, a preliminary inner surface is constructed. The surgeon is then presented with a set of grid points which are superimposed on the bone model and can be manipulated in 3D to alter the bone-interface surface. This manipulation enables thinner or thicker prostheses to be generated as necessary, requiring less or more bone removal, depending on the state of the bones. Once a model has been constructed, the remaining bone shape and the removed bone volume can be visualised. This visualisation is achieved by finely tessellating the NURBS surface into a set of small facets. An ‘inside/outside’ test is performed on each voxel around a region of interest near the knee against the facets in order to determine whether each voxel is part of the remaining bone or the removed bone. Visualisation tools allow either the remaining bone or the removed bone to be viewed, such visualisation enabling a surgeon to decide whether the NURBS surface needs to be re-modelled to remove more or less bone.

Interactive positioning can be performed on various 2D images, preferably from more than one different viewpoint, to obtain the correct geometry for the outer surfaces of the prosthesis to enable mating with the bone surfaces. A simple wire-frame model of the outer prosthesis surface is superimposed on the bone images and manipulated until the correct position is achieved. Angular measurements of the prosthesis and the bone axes allow the surgeon to set up the correct knee valgus and prosthesis tilt angles.

As the inner surfaces of the prosthesis are not of interest at this stage, the bone interface is not modelled in detail. Simple polygonal cutting is used to remove bone approximately to ensure that the bone surfaces which will be subsequently removed are removed to a depth sufficient to prevent the model data interfering with the prosthesis surface data.

An initial default model of the internal surface is provided with the prosthesis model. This initial model is a slightly scaled down model of the outer shell. As the prosthesis is translated and rotated to achieve correct positioning, the control point set is translated and rotated therewith to ensure correct positioning of the initial bone-cutting surface. FIG. 2 illustrates a side view of the outer surface of the prosthesis and an inner NURBS surface.

An interactive control point editor enables individual control points within the NURBS surface to be grabbed and moved to alter the local curvature of the surface. For low-order surfaces, only nearby regions of the surface will be altered by moving a control point, so for interactive editing only a small fraction of the surface has to be re-drawn at any time.

In order to provide a unique mating position of the prosthesis with the bone, surface features, such as bumps or ridges, may be introduced in the surface by altering the height of selected control points on the surface. The surface normal for a NURBS surface can be determined from its derivatives, and the control points moved a short distance along the normals to provide bumps.

The NURBS surface is used as a discriminator to determine which sections of the voxel map remain within the bone after cutting, and which sections are to be removed. The voxel data is split into two data sets, one being for bone remaining and the other being for bone removed.

Surface models of the bone remaining or the bone removed are visualised in 2D or 3D. The data sets representing the bone remaining and the bone removed are converted to surface models using the Marching Cubes algorithm for 3D visualisation or shown slice-by-slice for 2D visualisation of the bone characteristics, represented by grey levels in the CT data.

Next, we turn to osteotomy planning.

Much of the methodology for osteotomy planning is similar to that for knee replacement planning as described above. A significant difference is, however, that there are no pre-defined prostheses. each being custom made. The precise form which the NURBS surfaces take for such osteotomies will depend on the surgery to be performed. For example. if a complete section of bone is to be replaced, two NURBS surfaces are required, one for each of the bone ends to be machined. FIG. 3 illustrates a complete bone section removal. Alternatively, where only a region is to be excised from a bone, still leaving the bone in one piece, and a plug is required to fill the excised region, the NURBS surface will represent the inner surface geometry of the plug. FIG. 4 illustrates a bone region removal.

In the other modelling descriptions herein, the visualisation procedure is based on modifying and merging surface models. For osteotomy planning in particular, however, for example, the removal of tumourous material, it is important to maintain the original volume CT data. This is because the volume data will contain intensity levels indicating the type of tissue involved. In the case of such osteotomies, it is important to be able to visualise from the removed/remaining images what type of tissue remains, for example, to ensure that a tumour is completely removed, and that no cancerous material is left in the remaining bone section.

In osteotomy planning, the NURBS surface editor is of more free form in its design as compared to that used in the above-described knee replacement planning, as the bone cutting surfaces are not based on a particular prosthesis shape, but can take any form. The NURBS surface is initialised to one or more flat planes whose control points can be manipulated by the surgeon to define the resection surfaces and volumes. Visualisation of the removed/remaining sections is important to ensure that tumours, for example, are completely removed. As well as 3D views, the data will be viewable slice-by-slice, allowing the internal structure of the bone to be observed.

FIG. 5 illustrates a flowchart for one NURBS-based osteotomy planner.

Editing NURBS control points is achieved by grabbing control points using an editing tool, for example, a mouse, and pulling those points to new locations. The NURBS surface is then re-computed as a wire-frame centred around the currently-selected control point and re-drawn to reflect the new curvature. For a low-order NURBS surface, changes in a control point will only effect a localised region, requiring only a small amount of re-drawing.

Visualisation of the NURBS data is achieved by using the NURBS surface or surfaces to cut the voxel map. This is achieved, as with the knee-replacement planning system, by tessellating and applying ‘inside/outside’ tests to determine whether to place specific voxels in an ‘included’ or ‘excluded’ buffer. For smooth 3D rendering, the resulting buffers can be processed using a Marching Cubes algorithm. For detailed internal examination of the bone characteristics, the resulting buffers can be viewed slice-by-slice, either individually grey scaled, or combined on a colour-coded display, for example, remaining bone in varying levels of green and removed bone in varying levels of red.

In the above modelling method, none-NURBS surface representations could also be used.

Next, we turn to a consideration of FIGS. 6 to 10, which relate to the simulation of cutting planes in bones. In particular, this preferred embodiment of the invention relates to the visualisation of cut surfaces and the cut bones, merged with a prosthesis model.

FIG. 6 illustrates a flowchart of the modelling method of this embodiment of the present invention.

In this modelling method, a modified Marching Cubes algorithm is utilised. The Marching Cubes algorithm is a technique for generating one or more triangles for each voxel on a surface. See Lorensen, W. E., Cline H. E. ‘Marching Cubes: A High Resolution 3D Surface Construction Algorithm’ Computer Graphics—Vol. 21, No 4, July 1987, pp 163-169. Because of the data available, a number of extensions to the standard algorithm are employed.

For ease of exemplification, the method described herein is simplified so as not to take into account gradients at triangle vertices, these being traditionally used for smooth shading, since many of the triangles will be re-positioned, making the computed gradients obsolete when the image is rendered. The algorithm is run as a two-pass algorithm, with the first pass generating basic vertex information and the second pass fine tuning this vertex information by interpolating between the grey levels (Houndsfield numbers) of the voxels to generate triangle vertices at a sub-voxel spacing. The information available in the program data sets allows each of the bones to be separated, providing individual models for each of the bones. This separation simplifies the back projection of the polygons since the truncation of the surfaces of each bone surface can be considered in isolation.

FIG. 7 illustrates a flowchart for the first pass of the modelling method.

The data structures resulting from the first pass through the data are two data arrays. The first data array contains a list of triangles. Each entry in the first data array comprises three elements, each being an index into the second data array which comprises a vertex table. Thus, each triangle references three coordinates. The vertex table consists of position data coded relative to the voxels. In the Marching Cubes algorithm, the positions of triangle vertices are nominally between adjacent voxels.

As an example, FIG. 8 illustrates the simple case where a bone edge just impinges onto a group of eight voxels.

In this case. the black circle represents a voxel within the bone and the white circles represent voxels outside the bone. In this configuration, the surface of the bone defined by these eight voxels is represented by the single triangle shown. More complex cases have multiple triangles, up to a total of five, which have to be processed for each group of eight voxels. The triangle sets for each of the 256 possible combinations of vertex conditions are found from a pre-computed look-up-table.

In the first pass, each of the triangle vertices is represented as a 32-bit binary code, where the X, Y and Z co-ordinates of the adjacent voxel are integer voxel co-ordinates, that is, a voxel x, y position with an image slice, with the image slice number (x, y) referenced from the top left of each slice and a voxel z position from the top slice in a set. In this context, adjacent is defined as with the X, Y, Z co-ordinate of the vertex rounded down. Each co-ordinate axis is assigned 10 bits. allowing for a co-ordinate volume of 1024×1024×1024 voxels. Current CT image slices normally have a maximum size of 512×512 pixels. Thus, the modelling method of this aspect of the present invention has room for improvement in imaging technology (of course, other bit-lengths (e.g. 64) could also be used: 64-bit words would encode X, Y, Z as 20 bits each). The remaining two bits are used as a direction indicator to determine the axis on which the vertex is located relative to the voxel co-ordinate (see FIG. 9). The bits are coded such that vertices in the X direction have the pattern 01, vertices in the Y direction have the pattern 10 and vertices in the Z direction have the pattern 11. The code 00 is reserved to indicate the end of the list. Thus, in this exemplified case, all three vertices have the same X, Y and Z voxel co-ordinate values, but each vertex will have a different axis code. The triangles are coded such that looking from outside of the bone, the vertices are listed anti-clockwise.

Although a Marching Cubes algorithm can easily be implemented in a single pass without encoding the co-ordinate values and instead computing the interpolated co-ordinate values during processing, the first encoding pass of the modelling method of this aspect of the present invention leads to data reduction and increases the processing speed. It would be possible to simply scan through the voxel array with the Marching Cubes algorithm, generating sets of triangles for each set of eight voxels without any knowledge of the surrounding vertices already processed. This data could be generated rapidly, but would result in multiple instances of the same vertex being generated. Consequently, large amounts of redundant data would be generated, with a resulting decrease in rendering speed as the same co-ordinate values are transformed multiple times. The computed interpolated co-ordinate values could also alternatively be stored in a vertex list, but scanning for duplicates before adding new data to the list would require triplets of high precision numbers (either floating or fixed point) to be compared. Typically, these numbers are 32-bit numbers for X, Y and Z co-ordinates, resulting in a three-fold increase in the amount of data requiring comparison. Since the duplicate checking procedure is at the centre of the Marching Cubes algorithm, being called every time a vertex is generated, any increase in processing complexity results in a speed detriment. By keeping to integers in the first pass, simple binary comparisons of 32-bit words, a natural processor word length, can be made, and by compressing the vertex array in this way, the array is more likely to be cacheable on modern CPU architectures, resulting in a further speed improvement. Scanning the vertex list for duplicates is optimised to scan just a portion of the list. This is possible since the CT voxel data is scanned in a second pass.

FIG. 10 illustrates a flowchart for the second pass of the modelling method. In this pass, the vertex codes are converted into actual co-ordinates as follows.

In the second pass, the vertex list is traversed and grey-scale images for the slices representing the Z and Z+1 values of the current vertex are cached. Because of the ordering of the triangles, the CT slices from values from Z−2 backwards can be dumped if these data slices are in memory.

Interpolation is performed based on grey levels as follows. The co-ordinate of the current vertex is extracted and its axis code examined. For an axis code in the X direction, interpolation is between (X, Y, Z . . . X+1, Y, Z). For an axis code in the Y direction, interpolation is between (X, Y, Z . . . X, Y+1, Z). For an axis code in the Z direction, interpolation is between (X, Y, Z . . . X, Y, Z+1). The grey levels G1, G2 for the two co-ordinates are determined and the exact crossing point of the two lines 0, G1->1, G2 and 0, T->1, T is then computed. The X value of this crossing point is used as the fractional part of the offset to the X, Y or Z component of the vertex as specified by the axis code. The coordinate produced is then scaled by the CT pixel spacing and the CT slice spacing to yield a co-ordinate measurement in real units, typically in mm.

This algorithm is advantageously relatively simple, and requires only a relatively small memory since only a maximum of three CT image slices are stored in memory at one time, that is, slices Z−1, Z, Z+1, along with the coded and real-unit vertex arrays.

Having positioned the prosthesis. the rotation and translation of the prosthesis from the origin is known. These angles and offsets are used to transform the model of the prosthesis surface and the cutting planes for the prosthesis components.

From the cutting plane information, a plane equation is formed along with a surface normal directed outwardly, that is, pointing through the bone to be removed. Each cutting plane is considered in turn. The co-ordinate list is scanned, and each co-ordinate is tested to determine its distance from the plane and the side of the plane. If the co-ordinate is outside the plane, then the normal vector of the plane is scaled by this distance. The co-ordinate is then moved back onto the plane by applying the scaled normal thereto. The process is then repeated for the next co-ordinate. When all co-ordinates have been considered, the process is repeated for the remaining planes. In knee replacements, the femoral and. tibial data sets are considered separately.

This process is particularly suitable for a total knee replacement implant, where there is no restriction to the extent of the cutting plane. In order to extend the concept to unicompartmental implants where only one condyle, or half the tibial plateau, is to be cut away, additional planes are included in the prosthesis model which combine to provide a region-of-interest volume. The same tests applied for cutting planes as described above are applied to these planes, except that only co-ordinates that are within the region-of-interest plane set are considered. These co-ordinates are then tested as above for cutting. Many unicompartmental prostheses have a curved cutting profile and it is proposed that for generic applications these curved cutting planes be represented as a series of flat planes.

Prosthesis models consist of similar tessellated surfaces to the bone model, so the triangles and vertices of those models can be added to the bone model fairly simply. This is achieved by concatenating the facet information from the bone and prosthesis models. Depending on the indexing scheme used to reference co-ordinate data from facets, for example, absolute pointers or indexed relative to the start of a particular co-ordinate list, the vertices need not in the former case be concatenated or in the latter case require concatenating and renumbering in the facet data set. In addition, the tibial and femoral components can be concatenated in various poses by rotating the two processed data sets and then merging in the same way. The merged data set can then be rotated and scaled prior to rendering.

Rendering can be accomplished by any of the existing methods, for example, depth sorting and Z-buffering, depending on the capabilities of the graphics hardware and the API provided by the computer. As the surface normals of the facets can be computed easily, visibility tests can be easily applied to reduce the number of graphics primitives that need passing to the renderer; the surfaces being closed and only those facets pointing towards the viewer needing to be considered. These normals also allow shading of the facets to be computed.

The final preferred embodiment is illustrated in FIGS. 11 to 14. This embodiment relates to a method of assessing the fit of a prosthesis component prior to surgery.

FIG. 11 illustrates a flowchart of the mobility testing method of this aspect of the present invention.

The bone attachment points of the ligaments are determined using an interactive process in which the attachment points are identified by the surgeon and marked using a cursor on the CT image. Ligament lengths can be determined by scanning with the leg in traction, and tracing the ligaments onto the CT image interactively in 3D. Because the ligaments may wrap around the bones as the knee is flexed, the ligaments are modelled by dividing into chains of short sections.

The data set for the prosthesis model includes a list of co-ordinates for the tibial and femoral components which identify the optimal contact points for the two components for a given flexion angle. By determining the vector between these two points for any current angle, a translation can be computed for the tibial component and the attached tibia relative to the femoral component. This vector is then rotated to correspond to the rotation angles of the femoral component as set by the surgeon. Since these angles are already known, it is a simple matter to apply the transformation matrix currently in operation to position and orient the femoral component within the planning system.

The above transformation provides for the appropriate displacement of the tibial component, and can be applied to the model. To apply the currently-selected rotation to this component, the current rotation angle is first corrected by adding in the angular components for the femoral component orientation. The tibial component and the tibia model can then be rotated through this composite angle around the contact point between the femur and the tibia.

This determination is performed by scanning through all the surfaces in one of the models. In a preferred embodiment. a sub-set of the surfaces can be defined for each model by discarding the most proximal femoral facets and the most distal tibial facets. Each of these surfaces, for example, in the combined femur/femoral component, is then tested for intersection with surfaces in the other bone/component composite model. In the simplest embodiment two facets are considered, one in the femur Fᵢ and one in the tibia Tⱼ. If the femur facet Fᵢ is considered, this facet Fᵢ is bounded by three lines L1, L2, L3 which represent the sides of the facet Fᵢ. The corners of the facet Fᵢ are C1 (x, y, z), C2 (x, y, z) and C3 (x, y, z). The lines L1, L2, L3 are described in parametric form, with L1 running from C1->C2, L2 running from C2->C3 and L3 running from C3->C1. The parametric line equations L1, L2, L3 for the femur facet Fᵢ can be solved simultaneously in turn with the plane equation for the tibial facet Tⱼ to determine whether the lines L1, L2, L3 intersect the plane on which the tibial facet Tⱼ lies, and then apply a second test to determine whether any of the lines L1, L2, L3 from the femur facet Fᵢ lie inside the triangle described by the tibial facet Tⱼ. If the tests indicate an intersection between facets on the two bone/prosthesis components, then there is a bone or prosthesis impingement at this location. ᵢ ranges through all the required facets for testing on the femoral component. ⱼ ranges through all the required facets for testing on the tibial component for a complete test. The simplest embodiment described is just a test for one pair of facets.

The above analysis will require minor modifications depending upon exactly what the first and second fitting models represent. For example, if they both represent prosthesis components, the test is to see whether the components will interfere; if one represents a prosthesis component and the other an uncut bone (i.e. the other part of the joint) the test is whether the bone will interfere with the prosthesis or vice versa; and so on.

A ligament is initially described by a straight vector from the attachment point on the femur to the transformed attachment point on the tibia. If the required length of the ligament is significantly longer than that measured interactively as set out above, and exceeds the allowable over-length proportion specified by the biomechanics and allowable mechanical properties of ligaments, the ligament will be considered over-stretched and the current pose considered impossible. If on the other hand, the length is within a predetermined threshold, a second test is performed on the ligaments. In this second test, each ligament is intersection tested with the bone/prosthesis models to determine whether the straight line ligament is obstructed by bone. If so, then the ligament segments will need to be moved away from the bone. An energy minimisation algorithm is then applied to the ligament segments to allow for those ligament segments to relax back to follow the shortest route around the bone. This is an iterative procedure, and once a minimum has been approached, the path length can be tested as above. This wrap around feature will be more necessary for the ACL and PCL than for the medial and lateral ligaments.

A simple stick figure is constructed showing the swing of the ankle by computing the end points of the bones for each angle. In addition, the ligaments are animated to indicate whether there are likely to be any tight spots in the movement.

In the determination of the prosthesis wear, the initial placement of the tibia and the tibial component is performed as described above, and the ligament lengths tested similarly. A further wear test and transformation is then performed. FIG. 12 illustrates a flowchart of the wear test. In this test, the medial and lateral ligaments are considered, these usually being the ligaments on which soft tissue balancing is performed in manual surgery to adjust the tension in the knee.

The impingement test set out above simply tested for an intersection of two triangles from the tessellated mesh of the tibia/tibial component and the femur/femoral component. Processing over this data set would effectively provide an outline of the region where the two components intersected. A further test is employed to determine the impingement depth.

In this test, assumptions are made concerning the data and the likely positions in order to simplify processing. These assumptions are as follows:

(1) The surfaces are relatively finely tessellated surfaces. As the prosthesis components have smooth surfaces. the surfaces have to be divided into small, tessellated regions in order to generate a good polygonal approximation.

(2) The outer surface component geometry is fairly simple. This is usually the case for prostheses where smooth curves are required.

(3) There is only at most limited impingement. that is, the modelled intersection region is not too deep. If there is significant impingement, the components are improperly located.

(4) The prosthesis components can be simplified so that only the relevant surfaces, that is, external surfaces, have to be checked.

In this testing scheme, each triangle in the tibial component model is tested against triangles in the femoral component model. For a particular tibial facet triangle Tᵢ, a normal vector Nᵢ is generated from its centre. This is where assumption (1) is relied upon. It is assumed that the centre of the triangle Tᵢ is a good representation of the position of the triangle Tᵢ as a whole. This assumption is reasonable for small triangles, but not for larger triangles. Each femoral facet triangle Fⱼ in the femoral model is tested to see if the normal vector Nᵢ passes therethrough. If the normal vector Nᵢ passes through any femoral facet triangle Fⱼ, the length of the normal vector Nᵢ from the tibial facet triangle Tᵢ to that femoral facet triangle Fⱼ is recorded. Since each of the corners of a triangle are ordered, it is possible to determine which directions of the normal vector Nᵢ are inside and outside the femoral component, respectively. This is where assumptions (2) and (4) are relied upon. If the geometry were too complex and bent back on itself, the inside and outside tests may not be correct for a particular triangle.

By way of example, FIG. 13 illustrates a simplified case of the modelling method. For ease of representation. the components are shown in 2D, as opposed to 3D. In this case, all the normals Nᵢ from the tibial component facets Tᵢ which pass through the femoral component are positive relative to the tibial facets Tᵢ, thereby indicating that there is no intersection between the two components.

In a preferred embodiment, the relevant surfaces are isolated in order to reduce processing time. As a large number of tests are required, isolating the relevant surfaces reduces processing time. For a particular tibial facet triangle Tᵢ, there may be a number of femoral facet triangles Fⱼ intersected by the normal vector Nᵢ. The closest intersected femoral facet triangle Fⱼ is taken as being representative of the surface being intersected, the more distant femoral facet triangles Fⱼ being taken to be on the other side of the prosthesis. This is where assumption (3) is relied upon. If the prosthesis components were to interfere too significantly, then this condition may be incorrect.

By way of example, FIG. 14 represents the case where there is some intersection between the femoral and tibial components. By way of exemplification, the normals N₂, N₅ of first and second tibial facets T₂, T₅ are considered. The normal N₂ of the first tibial facet T₂ intersects the femoral component in two places, one in a positive direction and the other in a negative direction relative to the first tibial facet T₂. As there is a negative direction intersection of the normal N₂ of the first tibial facet T₂, there is some interference between the first tibial facet T₂ and the femoral component. The normal N₅ of the second tibial facet T₅ again intersects the femoral component in two places, but both have a positive direction from the second tibial facet T₅. Thus, there is no interference at this point. Here, the first tibial facet T₂ would be marked with the intersection depth as measured for the negative normal direction vector N₂, while the second tibial facet T₅ would be marked as being safe. In addition to marking up the interfering first tibial facet T₂, the interfering femoral facet can also be marked up simultaneously.

The tests described above tested the tibial component against the femoral component. It would, however, be equally possible to test the femoral component against the tibial component.

Where this test is performed, then after processing, the rendered images of the prosthesis are animated. As the sequence is run, if the ligaments are tight at any point, those ligaments will effectively pull the prosthesis components into each other, resulting in an impingement therebetween. While in reality the two components would not pass through each other, the depth of theoretical interference in the simulation can be used as an indication of wear. The depth of the impingement is colour coded, for example, green for OK, that is, no impingement, through yellow, that is, slight allowable ligament stretching, to red, for unacceptable. This colour coding can be used during animation, with impinging areas being highlighted as the knee is flexed to visually indicate the likely wear patterns.

It will of course be appreciated that in all of the above modelling methods non-NURBS surface models could be used instead of NURBS-based models.

According to the particular surgical application, the two fitting models which are compared against one another may take various forms:

When extensive surgery is to be carried out, the two models generated are:

model1=cut bone model1+prosthesis model1

model2=cut bone model2+prosthesis model2

We want to test the interference between model1 and model2.

If we can be sure that a prosthesis component completely shrouds one bone (e.g. bone1), we only need to consider:

model2=cut bone model2+prosthesis model2

If we can be sure that both prosthesis components completely shroud each bone, we only need to consider:

test interference between prosthesis model1and prosthesis model2

If the prosthesis is only on one component (e.g. humeral replacement), then we need to consider:

test interference between prosthesis model1 and uncut bone model2

This last approach, is used, for example. for humeral replacement, where there is no scope for the remaining section of bone interfering with anything. In upper humeral replacement, typically the upper part of the humerus is completely replaced by a ball-ended metal component. The cup that it sits in (in the scapula) is not resurfaced with an implant.

Alternatively, the following test could be applied:

model1=cut bone model1+prosthesis model1, test interference between model1 and uncut bone model2.

In general, if we use the following terminology:

(u1)=uncut bone model1, (c1)=cut bone model1, (p1)=prosthesis1

(u2)=uncut bone model2, (c2)=cut bone model2, (p2)=prosthesis2

Then we need to consider the following interacting combinations of ‘fitting models’:

c1+p1 & c2+p2

p1 & c2+p2

p1 & p2

c1+p1 & u2

p1 & u2

Along with the reverse situations (in which we swap over the 1s and the 2s).

In situations where one or (or preferably both) bone models can be eliminated, processing times can be greatly reduced.

It will be appreciated, of course, that in all of the above the reference to a “bone model” refers to a model of the relevant (local) parts of the bone. Distant parts that will not be cut and that cannot possibly. interfere need not be modelled.

In FIG. 11, the expressions “Process bone to simulate cuts” and “Merge bone and prosthesis models” need to be understood with all of the above possibilities in mind. These steps need to be carried out only if necessary for the surgical configuration and may be omitted or modified where applicable.

Finally, it will be understood that the present invention has been described in its preferred embodiments and can be modified in many different ways without departing from the scope of the invention as defined by the appended claims.

1. A method of modelling for use in surgical planning, the method comprising:
(a) generating a bone model including a NURBS surface describing a first fitting surface of a bone to which a prosthesis component is to be fitted;
(b) providing a prosthesis shell model describing a prosthesis component, the prosthesis component including a second fitting surface;
(c) displaying superimposed representations of the bone model and the prosthesis model;
(d) translating and/or rotating one or both of the bone model and the prosthesis model to represent one fit of the prosthesis component to the bone;
(e) modifying the prosthesis or bone model by re-modelling at least one of the respective fitting surfaces;
(f) generating a modified bone or prosthesis model;
(g) passing the bone model to a surgical robot; and
(h) using the prosthesis shell model to generate a prosthesis component.

2. A method as claimed in claim 1 in which the prosthesis shell model is used to generate a knee implant.

3. A method as claimed in claim 1 in which the prosthesis shell model is used to generate an osteotomy component.

4. A method as claimed in any one of claims 1 to 3 including splitting the bone model into bone-removed and bone-retained data sets, and visualizing the said data sets separately.

5. A method of modelling for use in surgical planning, the method comprising:
(a) generating a bone model describing a first fitting surface of a bone to which a prosthesis component is to be fined;
(b) providing a prosthesis shell model describing a prosthesis component, the prosthesis component including a second fitting surface;
(c) displaying superimposed representations of the bone model and the prosthesis model;
(d) translating and/or rotating one or both of the bone model and the prosthesis model to represent one fit of the prosthesis component to the bone;
(e) modifying the prosthesis or bone model by re-modelling at least one of the respective fitting surfaces;
(f) generating a modified bone or prosthesis model;
(g) passing the bone model to a surgical robot; and
(h) outputting the prosthesis shell model for use in the generation of a prosthesis component.

6. A method as claimed in claim 5 in which the prosthesis shell model is used to generate a knee implant.

7. A method as claimed in claim 5 in which the prosthesis shell model is used to generate an osteotomy component.

8. A method as claimed in any one of claims 5 to 7 including splitting the bone model into bone-removed and bone-retained data sets, and visualizing the said data sets separately.

9. A surface modelling method for modelling a three-dimensional surface, comprising
(a) determining any polygon in one voxel and the voxels adjacent thereto of a surface to be modelled;
(b) determining the polygon vertices of each determined polygon;
(c) encoding the polygon vertices as bit patterns, comprising, for each polygon vertex, the steps of:
(c1) encoding the polygon vertex as a bit pattern;
(c2) scanning a vertex list for the bit pattern;
(c3) including the bit pattern in the vertex list where the pattern is not in the vertex list; and
(c4) including an index of the bit pattern in a polygon table;
(d) repeating steps (a) to (c) for the other voxels of the surface to be modelled; and
(e) generating a vertex list and associated polygon table.

10. A method as claimed in claim 9 in which each bit pattern includes x, y and z voxel co-ordinates and a direction code representing the direction relative to the voxel co-ordinates.

11. A method as claimed in claim 10, further comprising:
(f) determining the z co-ordinate from one of the bit patterns;
(g) obtaining data for the cached image slices around the determined z co-ordinate;
(h) interpolating between voxels based on grey level and the direction code;
(i) generating a true x, y and z co-ordinate for the vertex;
(j) repeating steps (f) to (I) for the other bit patterns; and
(k) generating an x, y and z co-ordinate table for the vertices.

12. A method as claimed in claim 3 in which for any z co-ordinate, the cached image slices are slices z−1, z and z+1.

13. A method as claimed in any one of claims 9 to 12 in which the polygons comprise triangles.

14. A method as claimed in claim 9 further including, in a second pass, calculating the co-ordinate of vertex positions based on grey-scale values.

15. A modelling method, comprising:
(a) generating a bone model of a surface of a bone to which a prosthesis component is to be fitted by generating at least one polygon for each voxel on the surface of the bone as imaged;
(b) providing a prosthesis model describing a prosthesis component, the prosthesis component including a fitting surface;
(c) displaying superimposed representations of the bone model and the prosthesis model;
(d) translating and/or rotating one or both of the bone model and the prosthesis model to represent one fit of the prosthesis component to the bone;
(e) determining the relative translation and/or rotation of the fitting surface of the prosthesis component;
(f) generating a modified bone model by repositioning the vertices of the polygons of the bone model onto the fitting surface of the prosthesis component; and
(g) displaying the modified bone model.

16. A method as claimed in claim 15 in which the bone surface is an outer surface of the bone.

17. A method as claimed in claim 15 in which the bone surface is a surface of a cavity in the bone.

18. A method as claimed in any one of claims 15 to 17 in which the polygons comprise triangles.

19. A method as claimed in claim 14 in which the vertices are re-positioned by back-projection onto the said fitting surface.

20. A method of enabling the optimization of the fit of first and second relatively-moveable prosthesis components, comprising:
(a) positioning a prosthesis model of the first prosthesis component with respect to a first bone model, and a prosthesis model of the second prosthesis component with respect to a second bone model, to define respective first and second fitting models;
(b) simulating relative movement between the prosthesis components by moving one fitting model with respect to the other, subject to a constraint model;
(c) indicating any interference between the first and second fitting models;
(d) re-positioning the respective models of the first and second prostheses to define new first and second fitting models, and re-simulating movement;
(e) repeating (d) until a desired fit is achieved; and
(f) generating position data representative of the first and second fitting models for use in subsequent operation.

21. A method as claimed in claim 20 including displaying superimposed representations of the first and second fitting models.

22. A method as claimed in claim 21 in which any interference between the fitting models is indicated visually.

23. A method as claimed in claim 22 in which the visual indication comprises colour-coding.

24. A method as claimed in any one of claims 20 to 23 including generating cutting data from the position data for use in subsequent bone-cutting.

25. A method as claimed in any one of claims 20 to 24 in which the constraint model includes ligament length constraints.

26. A method as claimed in any one of claims 20 to 25 including providing an indication if the ligaments would be unduly stretched.

27. A method as claimed in any one of claims 20 to 26 including providing an indication of the likely wear on the prostheses due to tightness.

28. A method as claimed in any one of claims 20 to 27 including providing an indication of the typical gait of a patient having the prostheses in place.

29. A method as claimed in any one of claims 20 to 28 in which the first prosthesis component is a femoral prosthesis and the second prosthesis component is a tibial prosthesis.

30. A method of enabling the optimization of the fit of a prosthesis component for a joint, comprising:
(a) Defining a first fitting model including a model of the prosthesis and a second fitting model including a model of a further prosthesis or bone with which the prosthesis is to co-operate;
(b) simulating relative movement by moving one fitting model with respect to the other, subject to a constraint model;
(c) indicating any interference between the first and second fitting models;
(d) re-defining the first model and re-simulating movement; and;
(e) repeating (d) until a desired fit is achieved.

31. A method as claimed in claim 30 including displaying superimposed representations of the first and second fitting models.

32. A method as claimed in claim 31 in which any interference between the fitting models is indicated visually.

33. A method as claimed in claim 32 in which the visual indication comprises colour-coding.

34. A method as claimed in any one of claims 30 to 33 including generating cutting data for use in subsequent bone-cutting.

35. A method as claimed in any one of claims 30 to 34 in which the constraint model includes ligament length constraints.

36. A method as claimed in an) one of claims 20 to 35 in which the first fitting model is a model of the prosthesis and of the cut bone surface onto which it is to fit.

37. A method as claimed in claim 36 in which the second fitting model is of the further prosthesis and of the cut bone surface onto which the further prosthesis is to fit.

38. A method as claimed in claim 36 in which the second fitting model is of an uncut bone surface against which the prosthesis is to bear and move.

39. A method as claimed in claim 36 in which the second fitting model is of the further prosthesis.

40. A method as claimed in claims 30 to. 35 in which the first fitting model is a model of the prosthesis.

41. A method as claimed in claim 40 in which the second fitting model is of the further prosthesis and of the cut bone surface onto which the further prosthesis is to fit.

42. A method as claimed in claim 40 in which the second fitting model is of the further prosthesis.

43. A method as claimed in claim 40 in which the second fitting model is of an uncut bone surface against which the prosthesis is to bear and move.

44. A method as claimed in claims 30 to 39 including generating position data representative of the first and second fitting models for use in subsequent operation.
